(19) United States
(12) Patent Application Publication
(10) Pub. No.: US 2010/0064902 A1
(43) Pub. Date: Mar. 18, 2010

(54) DEVICE FOR DILUTING DISCHARGED STEAM AND COOKER WITH THE SAME

(76) Inventors: Yasuaki Sakane, Osaka (JP); Noriko Ina, Osaka (JP); Seiichi Hirano, Osaka (JP)

Correspondence Address: BIRCH STEWART KOLASCH & BIRCH, PO BOX 747, FALLS CHURCH, VA, 22040-0747, US

(21) Appl. No.: 12/513,302

(22) PCT Filed: Oct. 16, 2007
(86) PCT No.: PCT/JP2007/070113

§ 371 Date: May 1, 2009

(30) Foreign Application Priority Data
Nov. 2, 2006 (JP) 2006-298454

(51) Int. Cl. A47J 27/04

(52) U.S. Cl. 99/352; 99/474

(57) ABSTRACT

A cooker has a cooker main body and a discharged steam cooling unit placed at the top surface of the cooker main body. Inside the discharged steam cooling unit is a duct extending in the front/rear direction. The rear end of the duct is an inlet port connected to an outlet port of the cooker main body. A throat portion is formed in the duct. Air from a blower is blown into the throat portion through a nozzle to generate a suction force at the inlet port by an ejector effect. The duct is branched on the downstream side of the throat portion, and outlet ports are provided at the ends of the branched ducts. Ambient air is sucked in from a gap between the inlet port of the duct and the outlet port of the cooker main body.

### TECHNICAL FIELD

The present invention relates to a discharged steam diluting device that dilutes steam discharged from a cooker through a gas discharge passage, and a cooker provided therewith.

### BACKGROUND ART

Oven-type cookers for cooking food put in a heating chamber with a heat medium have been increasingly popular in households in Japan. Oven-type cookers employ various heating methods such as one using radiant heat, one using a heat medium, and one using a microwave. Some employ more than one of such methods in combination. Typical examples of the heat medium used in oven-type cookers are hot air obtained by heating air and superheated steam. Patent Document 1 listed below discloses a cooker using superheated steam as a heat medium. Patent Document 2 listed below discloses a cooker in which superheated steam and hot air can be selectively used as a heat medium.

Patent Document 1: JP-A-2005-195247

Patent Document 2: JP-A-2006-84082

### DISCLOSURE OF THE INVENTION

### Problems to be Solved by the Invention

In oven-type cookers using a heat medium for heating, the heat medium is brought into circulation while it is heated. In cases where steam is used as a heat medium, steam produced by a steam generating device joins the circulation flow. The heat medium, after it is heated, is strongly blown into a heating chamber to heat food at high speed.

The heat medium is blown into the heating chamber under pressure by a blower; to put it the other way around, interior pressure of the heating chamber increases. Too high interior pressure may cause a door of the heating chamber, which is maintained closed by the power of a spring, to be opened. To prevent this, a gas discharge passage is formed in the heating chamber such that, when the interior pressure of the heating chamber has risen too high, the heat medium is automatically discharged through the gas discharge passage. The gas discharge passage is also used to forcibly discharge the heat medium a little before the completion of cooking, for the purpose of reducing the amount of heat medium flowing toward the user when he/she opens the door of the heating chamber to take out food after the completion of cooking.

Gas discharged through the gas discharge passage not only is hot but also contains large amounts of steam and greasy fumes. As a result, if there is a wall immediately above or beside an outlet port, the wall is directly exposed to hot steam, and thus the wall may become undesirably wet.

The present invention has been made in view of the above problems, and an object of the present invention is to provide a device for use with a cooker that makes it possible to prevent the wall from becoming undesirably wet even when a cooker having a gas discharge passage for discharging gas from inside a heating chamber is placed near a wall.

### Means for Solving the Problem

To achieve the above object, according to one aspect of the present invention, a discharged steam diluting device diluting steam discharged from a cooker through a gas discharge passage is provided with a duct simultaneously sucking in and mixing steam discharged from the cooker with ambient air. Here, an outlet port of the duct is open in a predetermined direction.

With this structure, since steam discharged from the cooker through the gas discharge passage is mixed with ambient air and thereby diluted, it hardly causes a wall to become wet even if it flows toward the wall. Furthermore, a design such that the outlet port of the duct does not face a wall helps reduce the amount itself of discharged steam that flows toward the wall.

According to the present invention, in the discharged steam diluting device structured as described above, it is preferable that the predetermined direction in which the outlet port of the duct is open is a frontward direction or a diagonally frontward direction of the cooker.

With this structure, since steam, after it is diluted, is discharged from the cooker in the frontward or the diagonally frontward direction, even if the cooker is placed in a small space in a kitchen such as a space under a shelf cupboard or between a wall and a refrigerator, steam does not stay in the small space. This helps prevent a wall surface in the small space from becoming hot or prevent condensation from forming on the wall surface.

According to the present invention, in the discharged steam diluting device structured as described above, it is preferable that the duct have an inlet port at one end thereof and the outlet port at an other end thereof, that the inlet port be located so as to cover an outlet port of the gas discharge passage, and that a gap between the inlet port of the duct and the outlet port of the gas discharge passage function as an ambient air inlet port.

With this structure, there is no need of separately preparing an ambient air inlet port, and thus a simple structure can be achieved. In addition, even if the cooker is placed such that the outlet port is located near a wall surface, ambient air flows along the wall surface when it is sucked in, and this helps prevent condensation from forming due to gas discharged from the cooker.

According to the present invention, in the discharged steam diluting device structured as described above, it is preferable that a wind deflector be provided in the outlet port.

With this structure, the direction in which discharged gas flows from the cooker can be changed according to where the cooker is placed, and thereby the discharged gas can be led away from a place that it should not reach.

According to the present invention, in the discharged steam diluting device structured as described above, it is preferable that a throat portion having a reduced flow passage area be formed in the duct, and that wind from a blower be blown into the throat portion through a nozzle disposed coaxially with the throat portion to generate a suction force in the inlet port.

With this structure, since an ejector structure formed of the throat portion and the nozzle generates a suction force, sucked gas does not pass through the blower; as a result, the blower is not exposed to hot and highly humid gas, and thus it is free from damage due to hot and highly humid gas.

According to the present invention, in the discharged steam diluting device structured as described above, it is preferable that the duct be branched into two branch ducts on a downstream side of the throat portion, the two branch ducts each extending in diagonal directions to be increasingly away from each other, and that the outlet port be formed one at an end of each of the branch ducts.

With this structure, since two outlet ports are provided in right and left positions avoiding the center part of the cooker, even when the user stands in front of the cooker to look into the cooker through a see-through part of a door to check the cooking status, discharged gas flows away from the user. Thus, the user is free from the discomfort that would result from discharged gas blowing directly to him/her. In addition, a handle of the door, which is normally disposed at the top-center part of the door in oven-type cookers, can be prevented from being exposed to discharged gas.

According to the present invention, in the discharged steam diluting device structured as described above, it is preferable that a bottom surface of the duct be lowered toward the inlet port in a section from the inlet port to the throat portion to form a water drain passage for draining water to the outlet port.

With this structure, condensation formed on the surface of the section from the inlet port to the throat portion of the duct flows into the outlet port, and this saves the user time and trouble of dealing with the condensation.

According to the present invention, in the discharged steam diluting device structured as described above, it is preferable that the bottom surface of the duct be lowered toward the outlet port in a section from the throat portion to the outlet portion with a reservoir recess formed at a lowermost position.

With this structure, condensation formed on the surface of the section from the throat portion to the outlet port can be collected in the reservoir recess, and this prevents water from dripping down from the outlet port.

According to the present invention, in the discharged steam diluting device structured as described above, it is preferable that at least part of a top surface portion of the duct be formed detachable.

With this structure, part of the top surface portion of the duct can be detached to easily clean an interior of the duct when it has become dirty with greasy fumes and the like.

According to the present invention, in the discharged steam diluting device structured as described above, it is preferable that at least part of the top surface portion of the duct be formed detachable, and that steam-leakage preventing means be provided at a fitting portion between the at least part of the top surface portion of the duct that is formed detachable and a main body of the duct at least in a section from the throat portion to the outlet port.

The interior pressure of the duct is positive downstream from the throat portion. This may cause steam to leak through the fitting portion between the detachable part of the top surface portion and the main body of the duct in the section from the throat portion to the outlet port. The provision of the steam-leakage preventing means in this position helps prevent this, and thus is significant in terms of enhancing the market appeal of the cooker.

According to the present invention, in the discharged steam diluting device structured as described above, it is preferable that the duct and the blower form a detachable discharged gas cooling unit that is separate from the cooker main body.

With this structure, the duct and blower can be an option, and thus the user, if he/she does not need it, can purchase the cooker main body alone with less cost than otherwise.

According to the present invention, in the discharged steam diluting device structured as described above, it is preferable that, in the discharged gas cooling unit and in the cooker main body, positioning means be provided for determining relative positions of the discharged gas cooling unit and the cooker main body with respect to each other, and that an adapter be prepared for adapting the inlet port to the gas discharge passage.

With this structure, a single type of discharged gas cooling unit can be compatible with various types of cooker main bodies.

According to the present invention, in the discharged steam diluting device structured as described above, it is preferable that the discharged gas cooling unit and the cooker main body be connected to each other with a connector such that the discharged gas cooling unit is supplied with power and controlled from the cooker main body.

With this structure, the discharged gas cooling unit can be controlled in accordance with the operation of the cooker main body, and this saves the user time and trouble of manually operating the discharged gas cooling unit.

According to the present invention, in the discharged steam diluting device structured as described above, it is preferable that an electrical/electronic component isolation chamber be formed under a bottom surface of the discharged gas cooling unit.

With this structure, electrical/electronic components can be protected from a heat medium, steam, greasy fumes, and the like.

According to the present invention, in the discharged steam diluting device structured as described above, it is preferable that part of a top surface portion of the discharged gas cooling unit be formed as a detachable top lid that can be detached to disclose the interior of the duct.

With this structure, part of the top surface portion of the duct can be detached to easily clean the interior of the duct when it has become dirty with greasy fumes and the like.

According to the present invention, in the discharged steam diluting device structured as described above, it is preferable that the top lid be divided into a front and rear top lids, and that a wind deflector is provided in the front top lid for deflecting wind blowing out from the outlet port.

With this structure, not the whole top lid but the front top lid alone needs to be detached to clean the wind deflector when it has become dirty.

According to another aspect of the present invention, a cooker is combined with the discharged steam diluting device having any one of the structures described above.

With this structure, it is possible to provide a cooker that does not make a wall wet with gas it discharges.

### ADVANTAGES OF THE INVENTION

According to the present invention, since steam is discharged from a cooker through a gas discharge passage in a frontward direction or a diagonally frontward direction of the cooker after it is mixed with ambient air to be diluted, and thus a moisture source therein is reduced, even when the cooker is placed in a narrow space in a kitchen such as a space under a shelf cupboard or between a wall and a refrigerator, steam does not stay in the narrow space, and this helps prevent a wall surface in the narrow space from becoming hot or prevent condensation from forming on the wall surface. In addition, since a duct and a blower are integrated as a detachable discharged gas cooling unit that is separate from a cooker main body, the duct and blower can be an option, and thus the user, if he/she does not need them, can purchase the cooker main body alone at a lower cost than otherwise.

### BRIEF DESCRIPTION OF DRAWINGS

FIG. 1 is a perspective view showing the appearance of a cooker;

FIG. 2 is a front view of the cooker;

FIG. 3 is a front view showing a heating chamber, with the door to the heating chamber opened;

FIG. 4 is a schematic sectional view illustrating how a food tray is used;

FIG. 5 is a diagram for illustrating the overall structure;

FIG. 6 is an enlarged sectional view of a gas discharge passage;

FIG. 7 is a front view of a discharged gas cooling unit;

FIG. 8 is a top view of the discharged gas cooling unit;

FIG. 9 is a horizontal sectional view of the discharged gas cooling unit;

FIG. 10 is a partially-enlarged vertical sectional view taken along line A-A in FIG. 9;

FIG. 11 is a diagram showing the bottom surface of the discharged gas cooling unit;

FIG. 12 is a control block diagram;

FIG. 13 is a horizontal sectional view showing the discharged gas cooling unit combined with a cooker main body of a different type;

FIG. 14 is a perspective view of an adapter; and

FIG. 15 is a perspective view of the adapter as seen from a different direction.

### LIST OF REFERENCE SYMBOLS

1 cooker
2 cooker main body
3 discharged gas cooling unit
11 door
12 handle
20 heating chamber
30 outer circulation passage
32 blower
40 heat medium heating portion
60 steam generating device
77 leak passage
78 gas discharge passage
79 damper
90 control device
124 outlet port
126 water drain port
150 casing
152 duct
152L, 152R branch ducts
153 inlet port
154 outlet port
155 throat portion
156 nozzle
157 blower
162 gap
163 front top lid
164 rear top lid
165 wind deflector
166 isolation chamber
167 lid
168 reservoir recess
170 adapter

### BEST MODE FOR CARRYING OUT THE INVENTION

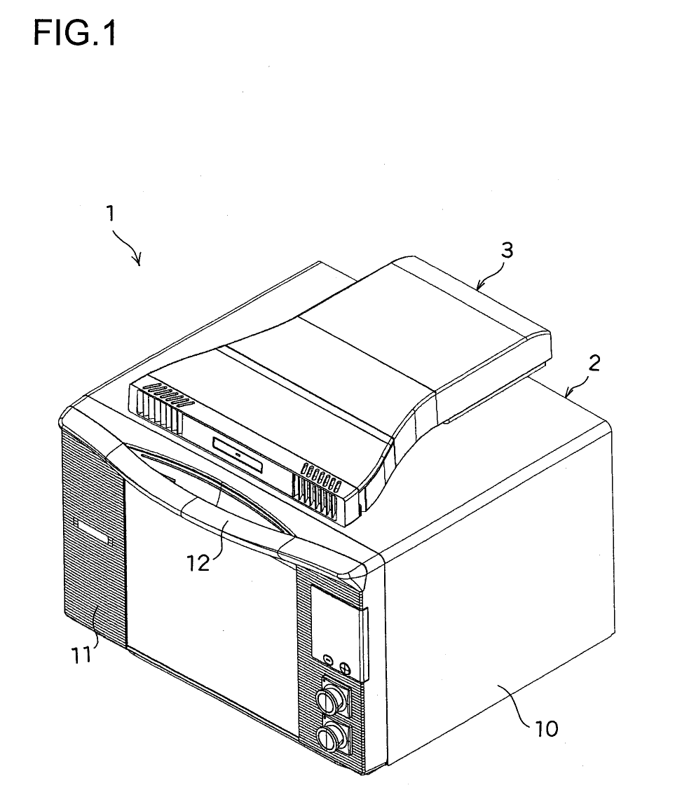

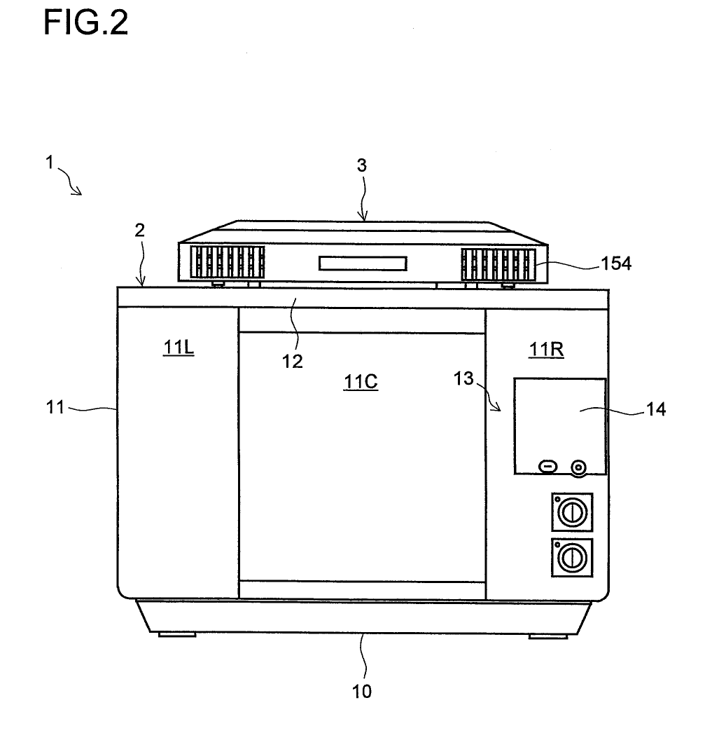

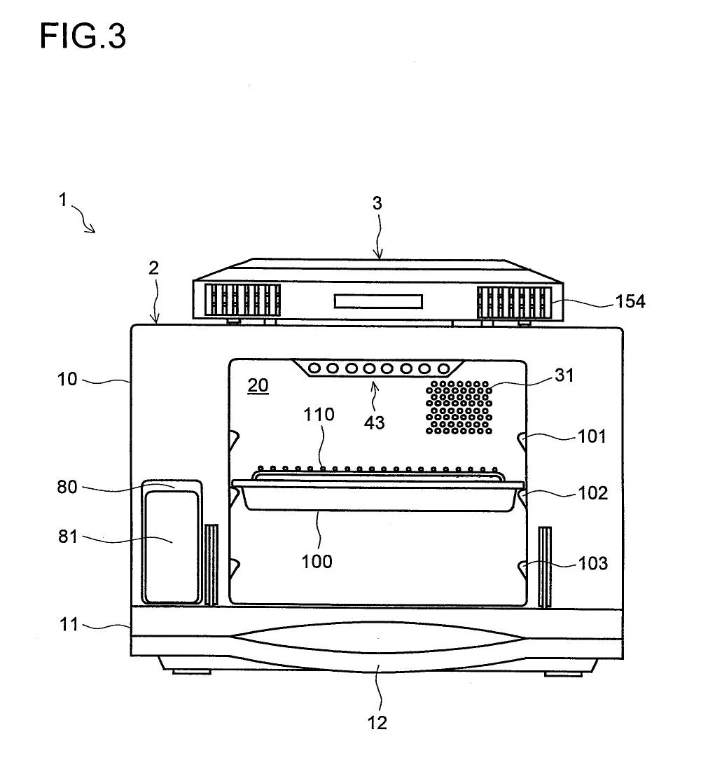

A description will be given of an example of a cooker provided with a discharged steam diluting device of the present invention with reference to FIGS. 1 to 12. A cooker 1 is provided with a cooker main body 2 and a discharged gas cooling unit 3. The structure of the cooker main body 2 will be described first. The cooker main body 2 has a cabinet 10 in the shape of a rectangular parallelepiped, and a door 11 is provided on the front face of the cabinet 10 for opening and closing an opening of a heating chamber 20. The door 11 rotates in a vertical plane about a door rotation axis (not shown) horizontally provided at the bottom thereof. When a handle 12 fitted in an upper part of the door 11 is held and pulled frontward, the door 11 changes its position through 90 degrees from a vertical, closed state shown in FIGS. 1 and 2 to a horizontal, fully-opened state shown in FIG. 3.

A middle part 11C of the door 11 has a pane of heat-resistant glass set therein to form a see-through part. On the left and right of the middle part 11C, a left-side part 11L and a right-side part 11R, each finished with a metal decoration plate, are arranged symmetrically. On the right-side portion 11R, an operation portion 13 is provided. In this specification, “left side” and “right side” denote the left-hand side and the right-hand side, respectively, of the user standing facing the cooker 1. Also, in the cooker 1, parts closer to the user are referred to with expressions with the word “front”, whereas parts farther away from the user are referred to with expressions with the word “rear”.

When the door 11 is opened, a front face of the cabinet 10 appears as shown in FIG. 3. In the part of the cabinet 10 corresponding to the middle part 11C of the door 11, the heating chamber 20 is provided. In the part of the cabinet 10 corresponding to the left-side part 11L of the door 11, a water tank accommodating portion 80 is provided. In the part of the cabinet 10 corresponding to the right-side part 11R of the door 11, a control circuit board is arranged inside, with no opening provided in front thereof.

The heating chamber 20 has the shape of a rectangular parallelepiped, and an opening is formed in the front face thereof at which it faces the door 11 for putting and taking food in and out of the heating chamber 20. The other faces of the heating chamber 20 are formed of stainless steel plates. Around the heating chamber 20, heat insulation is applied.

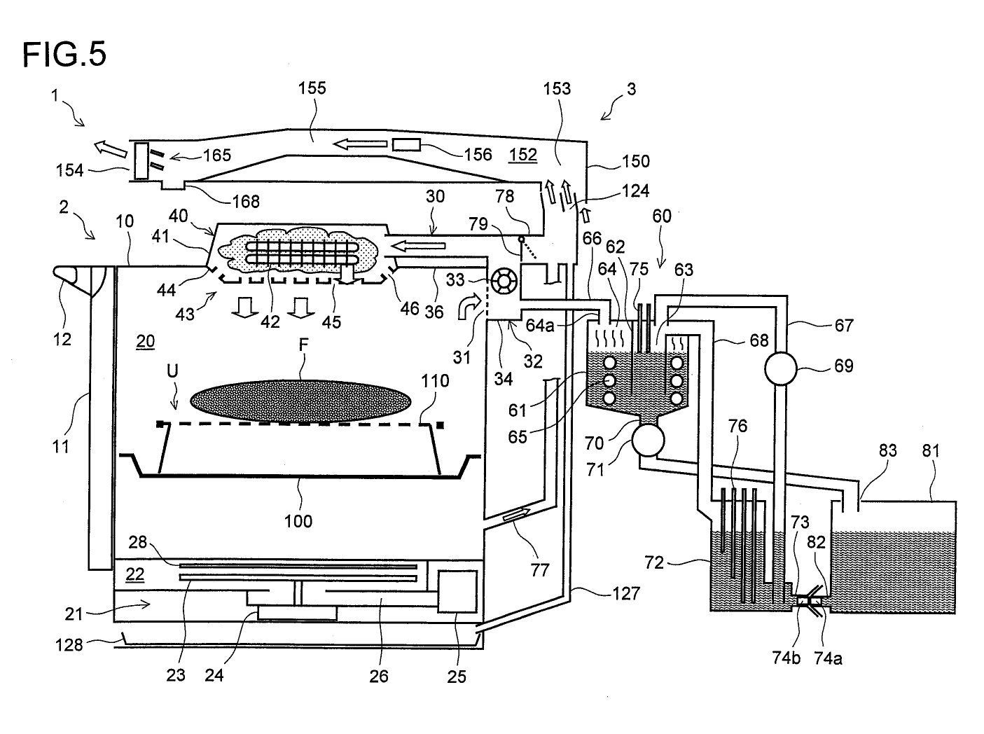

The cooker main body 2 is designed to use not only a heat medium but also a microwave to heat food. A description will be given below of how food is heated, mainly with reference to FIG. 5.

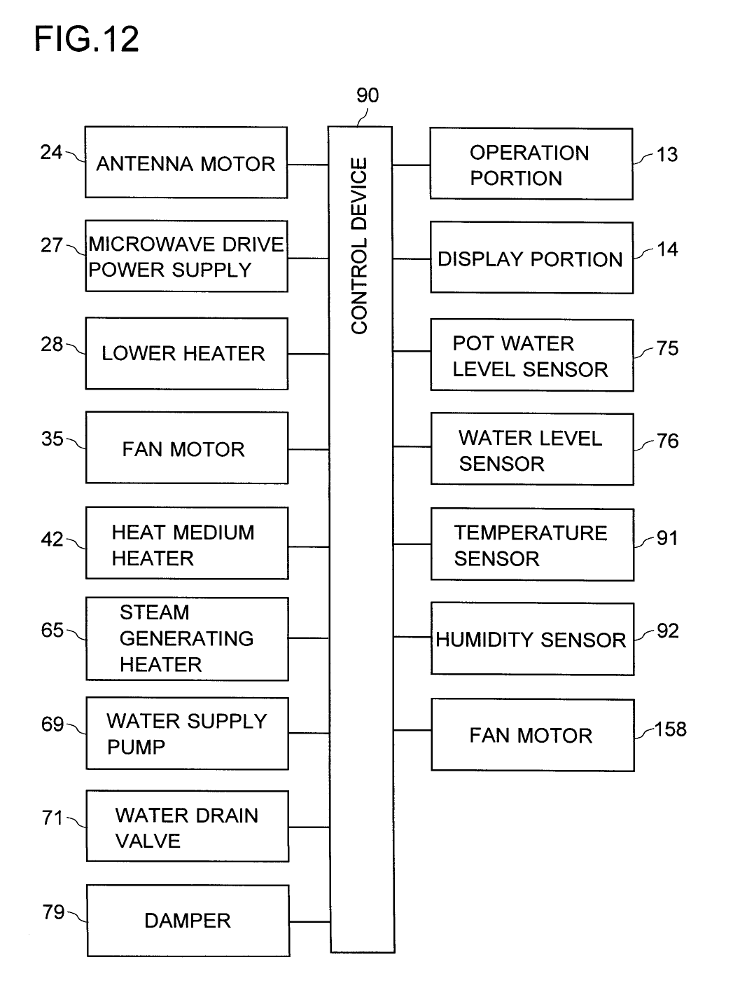

A microwave generating device 21 is disposed under a bottom part of the heating chamber 20. Specifically, the bottom part of the heating chamber 20 is made of a material such as glass or ceramics that transmits a microwave, and an antenna chamber 22 is formed thereunder. In the antenna chamber 22, an antenna 23 is accommodated, and the antenna 23 swings in a horizontal plane by being driven by an antenna motor 24. To the antenna chamber 22, a microwave is sent from a magnetron 25 through a waveguide tube 26, and the antenna 23 supplies the thus sent microwave into the heating chamber 20. The magnetron 25 oscillates with power supplied from a microwave driving power supply 27 (see FIG. 12).

Under the bottom part of the heating chamber 20, in addition to the microwave generating device 21, a lower heater 28 is disposed. The lower heater 28 heats the heat medium present inside the heating chamber 20 up to a predetermined temperature in cooperation with a heat medium heater 42, which will be described later.

The cooker 1 uses superheated steam or hot air as a heat medium, and the heat medium circulates along a circulation passage composed of the heat chamber 20 and an outer circulation passage 30. The outer circulation passage 30 starts at an inlet port 31 formed at an upper part of a rear wall of the heating chamber 20. The inlet port 31 is formed as a set of small through holes.

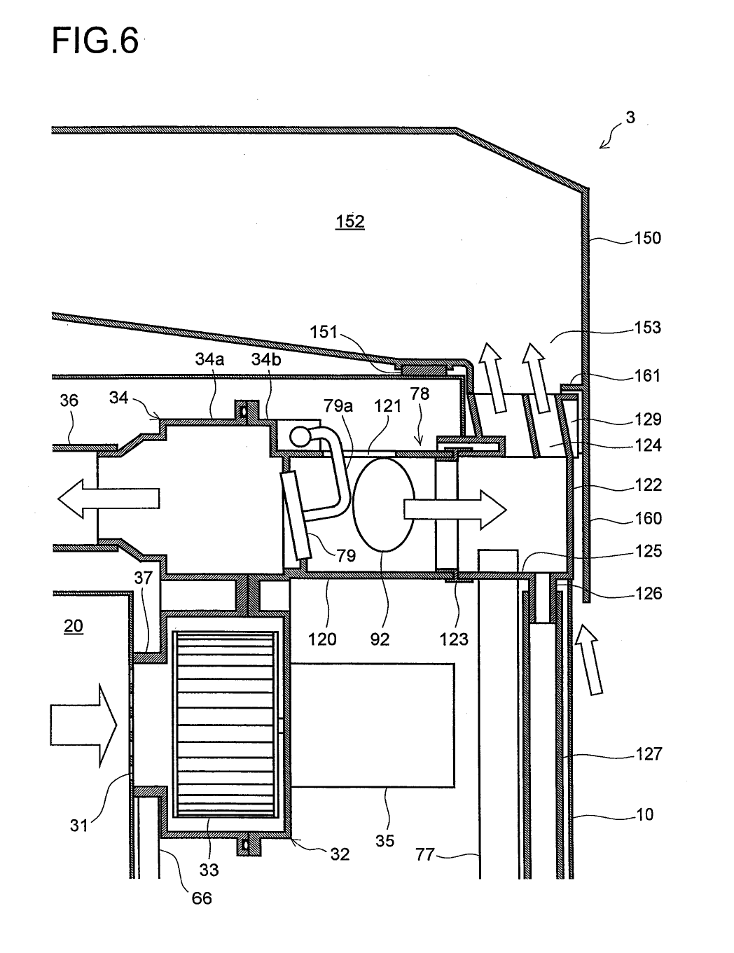

The inlet port 31 is followed by a blower 32. The blower 32 is fitted to the outer surface of the rear wall of the heating chamber 20. The blower 32 is provided with a centrifugal fan 33, a fan casing 34 accommodating the centrifugal fan 33, and a fan motor 35 (see FIG. 6) that rotates the centrifugal fan 33. Used as the centrifugal fan 33 is a sirocco fan. Used as the fan motor 35 is a direct-current motor capable of high-speed rotation.

The heat medium discharged from the fan casing 34 is sent through a duct 36 to a heat medium heating portion 40. The heat medium heating portion 40, which is composed of a heat medium heating chamber 41 formed above a ceiling part of the heating chamber 20 and the heat medium heater 42 disposed in the heat medium heating chamber 41, is provided at a position corresponding to the center of the ceiling part of the heating chamber 20 as seen from above. The heat medium heater 42 is built with a sheath heater.

The heat medium, after being heated at the heat medium heating portion 40, is supplied to the heating chamber 20 as jets coming from above and sideways into the heating chamber 20.

As previously described, the circulation passage of the heat medium has a simple composition and the shortest possible length, running from the inlet port 31 formed in the rear wall of the heating chamber 20, via the blower 32 fitted to the outer surface of the rear wall, to the heat medium heating portion 40 provided on the ceiling part of the heating chamber 20, and back to the heating chamber 20. This makes it easy to prevent entry of ambient air. Such a circulation passage makes it possible to feed an ample amount of steam into the heating chamber 20 to replace gas present inside the heating chamber 20 with the steam to achieve a low-oxygen state (where the oxygen density is 0.5% or less) that is an approximately oxygen-free state.

A description will be given below of how a jet is formed inside the heating chamber 20. An upper heat medium supply port 43 is provided at an upper part of the heating chamber 20. The upper heat medium supply port 43 is built as a jet cover 44, which is not only a bottom part of the heat medium heating chamber 41 but also a part of the ceiling part of the heating chamber 20. The jet cover 44 has the shape of an inverted dome that is trapezoidal in vertical section. A large part around the center of the jet cover 44 is formed as a horizontal surface, in which are formed a plurality of vertical jet holes 45 from which the heat medium is jetted vertically downward. The remaining part, which is around the horizontal surface, is formed as a tilted surface, in which are formed a plurality of oblique jet holes 46 from which the heat medium is jetted obliquely downward.

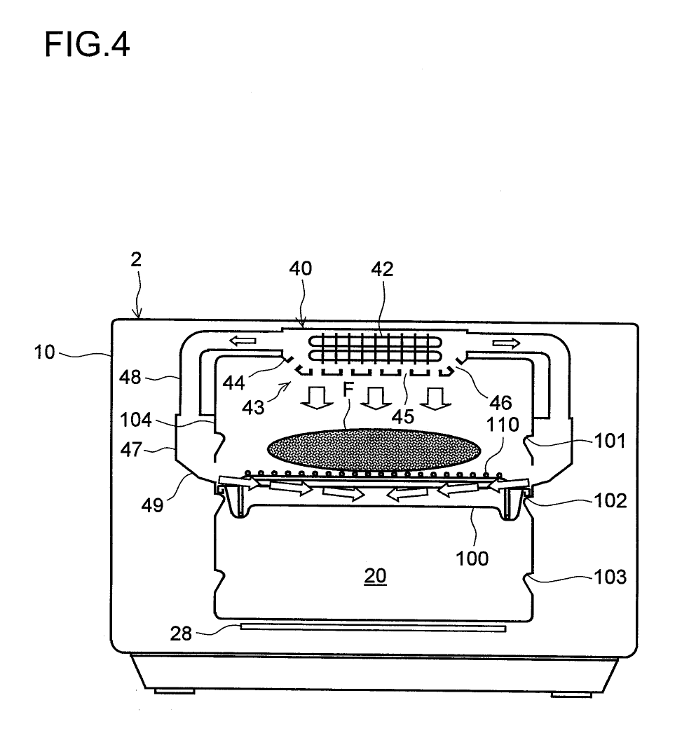

On the outer surfaces of the right and left side walls of the heating chamber 20, side heat medium supply ports 47 (see FIG. 4) are provided in a laterally symmetrical fashion. The heat medium is sent to the two side heat medium supply ports 47 through a duct 48 from the heat medium heating portion 40. The heating chamber-20 side of each of the side heat medium supply ports 47 is formed as an opening, from which the heat medium flows into the heating chamber 20 as a jet. That is, these parts function as jet-flow forming portions. Bottom parts of the side heat medium supply ports 47 function as guide portions 49 for determining directions of jets.

The cooker 1 is provided with a steam generating device 60 for generating steam as the heat medium. The steam generating device 60 has a cylindrical pot 61 disposed such that its centerline is vertically positioned.

The interior of the pot 61 is concentrically separated by a cylindrical partition 62; the section inside the partition 62 is a water level detecting chamber 63 and the section outside the partition 62 is a steam generating chamber 64. The partition 62 reaches near the bottom of the pot 61, and the water level detecting chamber 63 and the steam generating chamber 64 communicate with each other in water. The upper space of the water level detecting chamber 63 communicates with the atmosphere. In the steam generating chamber 64, a steam generating heater 65 formed as a coiled sheath heater is disposed for heating water. In an upper part of the steam generating chamber 64, a steam deriving pipe 64a is provided to lead to a steam supply pipe 66. In the figure, the steam deriving pipe 64a is disposed in the ceiling of the pot 61, but it may be disposed in the side of the pot 61.

The exit part of the steam supply pipe 66 is connected to the suction side of the fan casing 34. Thus, the fan casing 34 functions as a steam supply portion supplying steam to the circulation passage. The steam supply pipe 66 is built with a flexible tube such as a rubber tube or a silicone tube. In a case where the steam deriving pipe 64a is integrally formed with the pot 61, the steam deriving pipe 64a is inserted into the steam supply pipe 66 to link the steam supply pipe 66 to the pot 61.

A water supply pipe 67 and an overflow pipe 68 are each connected to the pot 61 so as to communicate with space in the upper part of the water level detecting chamber 63. Water is poured into the pot 61 through the water supply pipe 67 from a water tank 81 accommodated in the water tank accommodating chamber 80 (see FIG. 3), and a water supply pump 69 is provided on the way along the water supply pipe 67. The bottom part of the pot 61 is formed in the shape of a funnel, and a water drain pipe 70 extends therefrom. A water drain valve 71 is provided on the way along the water drain pipe 70.

The water supply pump 69 sucks water up not directly from the water tank 81 but from an intermediate tank 72 which is connected to the water tank 81. From the bottom of the water tank 81, an outlet pipe 82 protrudes toward the rear of the water tank accommodating chamber 80, and the outlet pipe 82 is connected to an inlet pipe 73 protruding laterally from the intermediate tank 72.

When the water tank 81 is pulled out from the water tank accommodating portion 80, the outlet pipe 82 is disconnected from the inlet pipe 73, and thus, unless some measure is taken, the water inside the water tank 81 and the intermediate tank 72 spills out. To prevent this, the outlet pipe 82 and the inlet pipe 73 are fitted with coupling plugs 74a and 74b. In the state where the outlet pipe 82 is connected to the inlet pipe 73 as shown in FIG. 5, the coupling plugs 74a and 74b couple to each other to permit passage of water; when the outlet pipe 82 is disconnected from the inlet pipe 73, the coupling plugs 74a and 74b are each shut to prevent water from spilling out of the water tank 81 and the intermediate tank 72.

The water supply pipe 67 enters the intermediate tank 72 and an end thereof extends close to the bottom of the intermediate tank 72. The overflow pipe 68 is connected to the upper space of the intermediate tank 72. The upper space in the intermediate tank 72 communicates with the atmosphere via an unillustrated pressure release opening, and thus the upper space in the water level detecting chamber 63 also communicates with the atmosphere. The water drain pipe 70 is connected to a water supply port 83 of the water tank 81.

In the water level detecting chamber 63, a pot water level sensor 75 is disposed for detecting the water level in the pot 61. In the intermediate tank 72, a water level sensor 76 is disposed for detecting the water level therein. The pot water level sensor 75 is composed of a pair of electrode rods extending vertically downward from a ceiling part of the water level detecting chamber 63, and the water level sensor 76 is composed of a total of four electrode rods extending vertically downward from a ceiling part of the intermediate tank 72. A GND electrode a potential at which is a reference potential and a positive electrode are included in the electrode rods. Of the four electrode rods of the water level sensor 76, two are longer than the other two, one of which is shorter than the other; the two longer electrodes extend close to a bottom part of the intermediate tank 72. Incidentally, the pot water level sensor 75 is located a little higher than the steam generating heater 65.

In the heating chamber 20, a leak passage 77 is formed to allow the heat medium to leak out of the heating chamber 20 to adjust the interior pressure of the heating chamber 20. On the other hand, in the fan casing 34, a gas discharge passage 78 is formed for discharging a large amount of heat medium at one stroke. At the entrance of the gas discharge passage 78, an electrically-operated damper 79 is provided for opening/closing the gas discharge passage 78.

As shown in FIG. 6, the fan casing 34 is formed by combining two shells 34a and 34b, and in the shell 34a, which is located on the side that faces the heating chamber 20, an inlet port 37 is formed to connect to the inlet port 31. Since pressure is negative at the suction side of the centrifugal fan 33, air tends to flow through the joint of the inlet port 37 and an outer surface of the heating chamber 20. To prevent this, it is necessary to firmly join the inlet port 37 to the outer surface of the heating chamber 20. This is because inflow of air through the joint makes it difficult to realize oxygen-free cooking which will be described later. To achieve this object, air inflow preventing means is provided at the joint of the outer surface of the heating chamber 20 and the inlet port 37.

The air inflow preventing means is realized by taking one of or a combination of various measures including: forming the inlet port 37 in a circular shape to make it easy for pressure to be uniformly applied to the inlet port 37; disposing a sealing member between the outer surface of the heating chamber 20 and the inlet port 37; and using a large number of bolts in joining the fan casing 34 to the heating chamber 20 with bolts. By taking elaborate measures to prevent air from intruding through this portion, the minimum oxygen density inside the heating chamber 20 after the gas inside the heating chamber 20 is replaced with steam, which is otherwise approximately 1%, can be reduced down to approximately 0.5%.

On the other hand, in the shell 34b, which is located on the side that is away from the heating chamber 20, a duct 120 forming a front half of the gas discharge passage 78 is formed back-to-back with an outlet portion through which the heat medium is discharged into the duct 36. The duct 120 extends toward the rear side of the cabinet 10, and in an upper surface thereof, an opening 121 is formed through which an arm 79a of the damper 79 is inserted. Through the opening 121, the gas discharge passage 78 communicates with the atmosphere.

To an end of the duct 120, an end cap 122 forming a rear half of the gas discharge passage 78 is connected via a gasket 123. In an upper surface of the end cap 122, an outlet port 124 is formed through which gas is discharged upward. In order to discharge gas in a predetermined direction, the outlet port 124 has a ventilation-grill structure.

At a position in a rear top corner of the cabinet 10, the end cap 122 is exposed to the outside of the cooker 1. The outlet port 124 is also exposed to the outside of the cooker 1. Gas is discharged from the outlet port 124 not in a vertically upward direction but in a direction that is tilted a little forward with respect to the vertically upward direction. This is for preferably preventing, when the cooker 1 is placed close to a wall, discharged gas from staining the wall behind the cooker 1. Incidentally, the leak passage 77 is also connected to the end cap 122.

When the heat medium enters the gas discharge passage 78, since the temperature of an inner wall of the gas discharge passage 78 is not high, steam contained in the heat medium condenses on the inner wall of the gas discharge passage 78. The water resulting from the condensation runs along the inner wall down to a bottom part of the gas discharge passage 78. Also, if water is splashed on the outlet port 124 for some reason, the water flows into the gas discharge passage 78 and also runs down to the bottom part of the gas discharge passage 78. In order to prevent a humidity sensor, which will be described later, from becoming wet with the water resulting from the condensation and the water flowing in through the outlet port 124 (which will hereinafter be collectively referred to as “water”), an infiltration-water retreat portion 125 is formed at the bottom part of the gas discharge passage 78. In a first embodiment, the infiltration-water retreat portion 125 is formed in a bottom part of the end cap 122. In the infiltration-water retreat portion 125, a water drain port 126 is formed, and a water drain hose 127 is connected to the water drain port 126. The water drain hose 127 drains water to a water receiving pan 128 (see FIG. 5) placed in a bottom part of the cabinet 10.

The operation of the cooker 1 is controlled by a control device 90 shown in FIG. 12. The control device 90 includes a microprocessor and a memory, and controls the cooker 1 according to a predetermined program. The status of control is indicated on a display portion 14 in the operation portion 13. The display portion is built with, for example, a liquid crystal panel. The control device 90 receives operation instructions from various operation keys arranged on the operation portion 13 as they are operated. In the operation portion 13, a sound generating device is also arranged for generating various sounds.

Connected to the control device 90 are not only the operation portion 13 and the display portion 14 but also the antenna motor 24, the microwave drive power supply 27, the lower heater 28, the fan motor 35, the heat medium heater 42, the steam generating heater 65, the water supply pump 69, the water drain valve 71, the damper 79, the pot water level sensor 75, and the water level sensor 76. In addition to these, a temperature sensor 91 for measuring temperature inside the heating chamber 20 and a humidity sensor 92 for measuring humidity of gas that is being discharged through the gas discharge passage 78 are connected to the control device 90. The humidity sensor 92 is disposed in the duct 120 above a bottom surface of the duct 120, specifically on an inner wall of the duct 120 downstream side of the damper 79 in the gas discharge direction.

Food F is supported inside the heating chamber 20 by a food tray 100 forming a food support unit U together with a food support net 110. In the heating chamber 20, a tray holder is provided for holding the food tray 100 at a predetermined height when the food tray 100 is inserted therein. In this embodiment, on both of the side walls of the heating chamber 20, the tray holder is formed for horizontally supporting the food tray 100 by holding right and left sides of the food tray 100.

As shown in FIG. 3, the tray holders are provided in three stages from the topmost stage to the bottommost stage. A first tray holder 101 located at the topmost stage supports the food tray 100 at a position above side flows of the heat medium flowing into the heating chamber 20 from the side heat medium supply ports 47. A second tray holder 102 located at a middle stage supports the food tray 100 at a position where the side flows of the heat medium flow to the food tray 100 from above. A third tray holder 103 located at the bottommost stage supports the food tray 100 at a position a predetermined distance below the second tray holder 102. The first, second, and third tray holders 101, 102, and 103 are formed as ridge-like structure protruding from the side walls of the heating chamber 20.

When the food F is one from which melted fat and meat juice drip while it is cooked, or one that requires the heat medium to flow along the bottom surface thereof, the food support net 110 is placed above the food tray 100, and the food F is placed on the food support net 110.

As cooking modes, the cooker 1 has: a hot-air cooking mode in which heat is applied by use of hot air; a steam cooking mode in which heat is applied by use of steam; and a microwave cooking mode in which heat is applied by use of a microwave. The steam cooking mode includes a steam roasting mode in which heat is applied by use of superheated steam and a steaming mode in which food is steamed with saturated steam.

The cooker main body 2 is operated and operates as follows. In a case of cooking in the steam roasting mode using superheated steam as the heat medium, first, the door 11 is opened, then the water tank 81 is taken out from the water tank accommodating portion 80, and then water is poured into the water tank 81 through the water supply port 83. Filled with water, the water tank 81 is then put back into the water tank accommodating portion 80 and is set in position. When the outlet pipe 82 is confirmed to have been securely connected to the inlet pipe 73 of the intermediate tank 72, the food tray 100 is put in the heating chamber 20 with food put thereon with the food support net 110 therebetween, and the door 11 is closed, And then, operation keys provided on the operation panel 13 are pressed as necessary to select an option from a cooking menu or to make various settings, and cooking is started.

When the outlet pipe 82 is connected to the inlet pipe 73, the water tank 81 and the intermediate tank 72 communicate with each other, and levels of water in them become equal. Thus, the level of water in the water tank 81 can also be measured by the water level sensor 76 that measures the level of water in the intermediate tank 72. If the amount of water inside the water tank 81 is found to be sufficient to execute the selected option in the cooking menu, the control device 90 starts to generate steam; if the amount water inside the water tank 81 is found to be insufficient to execute the selected option in the cooking menu, the control device 90 indicates the corresponding warning on the display portion 14. In this case, the control device 90 does not start to generate steam until the shortage of water is overcome.

When it becomes possible to start to generate steam, the water supply pump 69 starts to operate, and starts to supply water to the steam generating device 60. At this point, the water drain valve 71 is closed.

Water collects inside the pot 61 from the bottom thereof up. When the water level there reaches a predetermined level, the operation of the water supply pump 69 is stopped. Incidentally, if the water supply pump 69 fails to stop its operation due to failure in the control system or for other causes, the water level inside the pot 61 continues to rise beyond a predetermined level; however, when it reaches an overflow level, the water inside the pot 61 returns to the intermediate tank 72 through the overflow pipe 68. Thus, water does not overflow from the pot 61.

Now, electric power starts to be supplied to the steam generating heater 65. The steam generating heater 65 heats the water inside the steam generating chamber 64 directly. The temperature of water inside the water level detecting chamber 63 also rises as a result of water circulating between the water level detecting chamber 63 and the steam generating chamber 64 through the communicating portion and also as a result of heat transfer to the water level detecting chamber 63 through the partition 62; however, the rising rate of the temperature is moderate compared with that of the water inside the steam generating chamber 64.

When the water inside the steam generating chamber 64 boils to generate saturated steam, electric power stops being supplied to the steam generating heater 52. Now electric power starts to be supplied to the blower 32 and the heat medium heater 42. The blower 32 sucks in air from the heating chamber 20 through the inlet port 31. The blower 32 also sucks in saturated steam from the steam generating device 60 through the steam supply pipe 66. The air and the saturated steam is mixed together and the mixture gas of the air and the saturated steam is discharged by the blower 32 to be sent into the heat medium heating portion 40 via the duct 36. At this time, the damper 79 closes the entrance of the gas discharge passage 78.

The steam that has entered the heat medium heating portion 40 is heated to 300° C. by the heat medium heater 42, and is thus turned into superheated steam. The superheated steam jets into the heating chamber 20 from the upper heat medium supply port 43 as downward and obliquely downward jets. Part of the superheated steam flows through the ducts 48 into the side heat medium supply ports 47, and is then jetted out into the heating chamber 20 as a little downward sideway heat medium jets through the side heat medium supply ports 47. These jets of the superheated steam, too, heat the food F.

In heating by use of superheated steam, food F is heated by not only heat transferred by convection (specific heat of steam 0.48 cal/g/° C.) but also condensation heat (latent heat) generated when superheated steam condenses on the surface of the food F. A large amount of heat can be applied in the form of the condensation heat, which is as large as 539 cal/g, and thereby the food F is heated quickly. In addition, the superheated steam condenses preferentially on a low-temperature part of the surface of the food F, and this helps reduce unevenness in heating.

When superheated steam comes in contact with food F whose surface temperature is low, it instantly condenses to form condensation to transfer a large amount of heat to the food F. Then, moisture contained in the food F starts to evaporate in a recovery process, and after the recovery process, the food F starts to be dried. In this way, the food F is cooked to be crisp on the surface while maintaining moist inside. Furthermore, in comparison with cooking by use of hot air, cooking by use of superheated steam is superior in deoiling effect, salt reducing effect, vitamin C degradation inhibiting effect, and oil oxidation inhibiting effect.

In cooking by use of superheated steam, the heat medium heater 42 is not necessarily supplied with electric power continuously; electric power is sometimes supplied to the lower heater 28 instead. Incidentally, the amounts of electric power consumption by the heaters are set, for example, such that the electric power consumption by the steam generating heater 65 is 1300 W, that by the heat medium heater 42 is also 1300 W, and that by the lower heater 28 is 700 W. Under the electric power allowances of ordinary households, it is impossible to simultaneously select two or more of these heaters as power supply targets to be supplied with electric power, and thus, duty control is adopted here to change the power supply target in turn in a time-division manner to obtain an optimum result. The same applies to the heating by use of hot air.

When the interior pressure of the heating chamber 20 increases, the steam present therein enters the gas discharge passage 78 via the leak passage 77, and blows out from the outlet port 124. The thus discharged steam is diluted at the discharged gas cooling unit 3, which will be described later.

As the steam generating device 60 continues generating steam, the water level inside the pot 61 falls. When the water level sensor 75 detects that the water level has fallen to a predetermined level, the control device 90 restarts the operation of the water supply pump 69. The water supply pump 69 sucks up water from the intermediate tank 72 to supply a given amount of water to the pot 61. When the pot 61 is refilled with water, the control device 90 stops the operation of the water supply pump 69 again.

On completion of cooking, the control device 90 indicates a corresponding message on the display portion 14 and sounds an alert. Notified with these message and alert that cooking has been finished, the user opens the door 11, and takes the food tray 100 out of the heating chamber 20. If no cooking is scheduled thereafter, the water discharge valve 71 opens and the water present inside the pot 61 is returned to the water tank 81.

In the steam cooking mode, saturated steam before turned into superheated steam is sent into the heating chamber 20 to steam cook the food F.

In the steam cooking mode, either in steam roasting mode or steaming mode, the damper 79 is positioned as shown in FIG. 6 to close the gas discharge passage 78 to inhibit steam from entering the humidity sensor 92 side of the gas discharge passage 78. This helps prevent gas containing a large amount of steam from coming in touch with the humidity sensor 92 to condense thereon. Furthermore, since the damper 79 inhibits steam from entering the gas discharge passage 78, the steam density inside the heating chamber 20 increases to reduce the oxygen density inside the heating chamber 20 to be close to zero; in this way, oxygen-free cooking can be achieved with ease.

In the steam cooking mode, the food F is heated with the oxygen density inside heating chamber 20 maintained 0.5% or lower. With oxygen density of this level, the cooking effects expected from oxygen-free cooking can be substantially fully achieved.

When the hot-air cooking mode in which hot air is used as a heating medium is selected, regardless of the amount of water present in the water tank 81, power supply to the heat medium heater 42 and operation of the blower 32 are immediately started. In this case, the food F is heated with a jet of hot air. As in the case of heating with superheated steam, power supply to the heat medium heater 42 and the lower heater 28 is controlled in a time-division manner.

If the door 11 is opened while cooking is being performed with superheated steam or hot air, it is likely that the superheated steam or the hot air inside flows toward the user. The same applies after the completion of cooking. To prevent this, when the door 11 is opened while a hot heat medium is circulating, the damper 79 is operated to open the entrance of the gas discharge passage 78 to lead the hot heat medium into the gas discharge passage 78.

When the microwave cooking mode in which heat is applied by use of a microwave is selected, the microwave generating device 21 is driven. The microwave generating device 21 can be used alone, and it can also be used together with superheated steam or hot air.

In microwave cooking, the damper 79 moves to a position where it allows steam to flow into the humidity sensor 92 side of the gas discharge passage 78. As a result, gas containing steam from the food is discharged out of the cooker 1. The humidity sensor 92 measures the humidity of this gas. When the measured humidity reaches a predetermined value or more, the control device 90 recognizes that steam has jetted out from the food F as a result of the food F fully heated, that is, cooking has been completed, and stops the microwave heating.

The damper 79, when it has moved to the position where it allows steam to flow into the humidity sensor 92 side of the gas discharge passage 78, closes the opening 121 from inside the gas discharge passage 78. This control prevents air from flowing in through the opening 121 to dilute steam, and prevents steam from leaking outside through the opening 121. This helps avoid the inconvenience of measurement error of the humidity sensor 92 becoming large.

As already mentioned, the food F placed on the food tray 100 is inserted in the heating chamber 20, and at this time, different tray holder is selected to support the food tray 100 for different options in the cooking menu. When cooking by use of superheated steam is selected, the food tray 100 should be supported by the second tray holder 102, and a corresponding message is indicated in the display portion 14 as an instruction. Cooking by use of hot air can be performed with the food tray 100 supported by any one of the first tray holder 101, the second tray holder 103, and the third tray holder 103. Cooking by use of hot air can also be performed using two food trays, that is, with two of the food tray 100 respectively supported by the first tray holder 101 and the third tray holder 103. When cooking using two food trays is selected, in the display portion 14 is indicated a message to the effect that the first tray holder 101 and the third tray holder 103 are to be used.

When the second tray holder 102 is used to hold the food tray 100, the food support net 110 is placed above the food tray 100, and the food F is placed on the support net 110 to float above the surface of the food tray 100. The food support net 110 can also exert its advantage when it is used with the food tray 100 supported by the first tray holder 101 or the third tray holder 103. However, when the food tray 100 is supported by the second tray holder 102, the use of the food support net 110 is substantially indispensable to allow the side heat medium jets flowing out in obliquely downward directions from the side heat medium supply ports 47 to flow along the bottom surface of the food F.

Superheated steam is blown downward from the upper heat medium supply port 43 onto the food F placed on the food tray 100 supported by the second tray holder 102. Furthermore, the side heat medium jets of superheated steam from the side heat medium supply ports 47 hit the surface of the food tray 100 to change their directions upward, superheated steam is also blown onto the bottom surface of the food F. In this way, superheated steam is blown both from above and from below onto the food F, and thus all parts of the food F evenly receive heat transferred by convection and condensate heat (latent heat) to be efficiently heated. Melted fat and meat juice dripping down from the food F is received by the food tray 100, and is discarded after cooking is finished.

Needless to say, the food F placed on the food tray 100 supported by the second tray holder 102 can be cooked by use of hot air. Being put on the food supporting net 110 above the food tray 100, the food F can be evenly heated with hot air blowing thereonto both from above and from below. In this case, too, melted fat and meat juice dripping down from the food F is received by the food tray 100, and is discarded after cooking is finished.

As described above, the humidity sensor 92 disposed on the inner wall of the gas discharge passage 78 is used in microwave cooking for determining whether or not cooking is finished. At this time, condensation is formed inside the gas discharge passage 78. Besides during microwave cooking, when the door 11 is opened during cooking with superheated steam, the damper 79 opens to allow a large amount of steam flow into the gas discharge passage 78 to form condensation.

The condensation flows down to the bottom part of the gas discharge passage 78. If the condensation accumulates so much that the humidity sensor 92 becomes wet with the condensation, the humidity sensor 92 cannot measure humidity. In this embodiment, however, since the infiltration-water retreat portion 125 is provided, the condensation flowing down to the bottom part of the gas discharge passage 78 retreats to the infiltration-water retreat portion 125, and thus does not accumulate so much as to make the humidity sensor 92 wet. Thus, humidity never fails to be measured.

In the infiltration-water retreat portion 125, the water drain port 126 is provided. This helps immediately discharge the condensation to prevent the humidity sensor 92 from becoming wet with water. Water flowing in through the outlet port 124 is also discharged from the water drain port 126, and thus never comes close to the humidity sensor 92.

Since the humidity sensor 92 is located to the upstream side of the infiltration-water retreat portion 125 in the air discharge direction, even if the condensation water rushes toward the humidity sensor 92, it is pushed back by discharged air pressure; thus the humidity sensor 92 is prevented from becoming wet with water.

The gas discharge passage 78 constantly communicates with the atmosphere via the opening 121. As a result, even if condensation forms on the humidity sensor 92, it can be easily dried off except while steam is being circulated, and this makes it possible for the humidity sensor 92 to perform accurate measurement of humidity.

Next, a description will be given of the discharged gas cooling unit 3 that functions as a device for diluting discharged steam with reference to FIGS. 5 to 11.

The discharged gas cooling unit 3 is to be placed on the top surface of the cooker main body 2, and has its main components accommodated in a casing 150 that is made of a synthetic resin. The casing 150 is in the shape of a flat box, but it is not rectangular in the plan view, the right/left width thereof a little wider toward the front edge (see FIG. 8). Elastic legs 151 formed of rubber or a soft synthetic resin are provided in proper positions on a bottom surface of the casing 150 to prevent vibration of the discharged gas cooling unit 3 from reaching the cabinet 10 and to prevent the discharged gas cooling unit 3 from easily sliding.

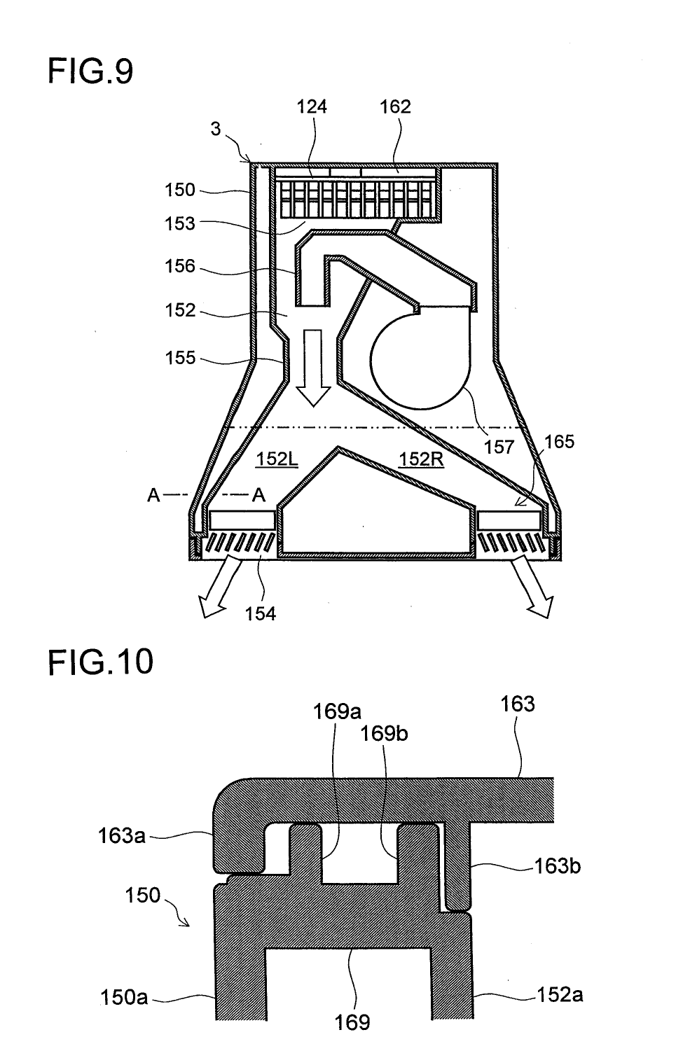

Inside the casing 150 is formed a duct 152 extending in the rear/front direction (see FIGS. 5 and 9). The rear end of the duct 152 is formed as an inlet port 153 and the front end of the duct 152 is formed as an outlet port 154. On the way along the duct 152, a throat portion 155 having a reduced flow passage area is formed. The duct 152 is branched into branch ducts 152L and 152R on the downstream side of the throat portion 155. The branch ducts 152L and 152R extend to be increasingly away from each other, and each have the outlet port 154 formed at its end. To fit with the outlet port 124, which is disposed rather in a left side of the cooker main body 2, the section of the duct 152 from the inlet port 153 to the throat portion 155 is disposed rather in a left side of the casing 150.

On the upstream side of the throat portion 155, a nozzle 156 is disposed to be coaxial with the throat portion 155. Through the nozzle 156, wind from a blower 157 (see FIG. 9) disposed outside the duct 152 is blown into the throat portion 155 toward the outlet ports 154. When wind is blown into the throat portion 155 from the nozzle 156, an ejector effect is created, and air is sucked in through the inlet port 153. Incidentally, the blower 157 has the same structure as the blower 32, and includes a centrifugal fan, a fan motor 158 (see FIG. 12) for rotating the centrifugal fan, and a fan casing accommodating the centrifugal fan and the fan motor 158. Used as the centrifugal fan is a sirocco fan, and used as the fan motor 158 is a direct-current motor capable of high-speed rotation. An inlet portion of the blower 157 is provided in the bottom surface of the fan casing.

The cooker main body 2 and the discharged gas cooling unit 3 are connected to each other with an unillustrated connector, and the discharged gas cooling unit 3 is supplied with power and controlled from the cooker main body 2. The fan motor 158 is controlled by the control device 90.

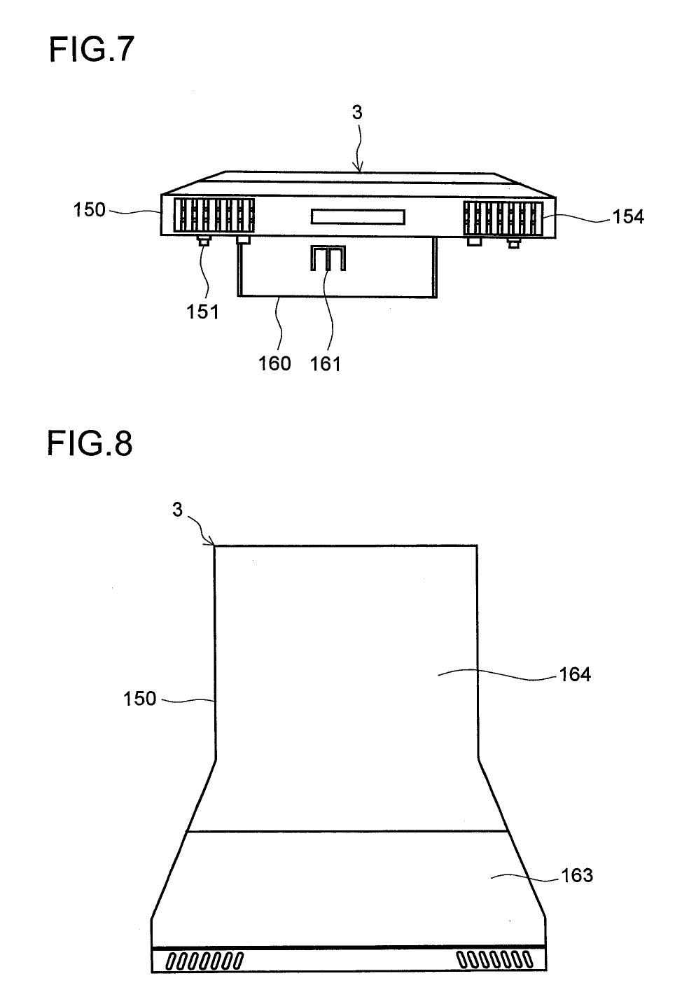

At a rear end of the casing 150, in a position corresponding to the outlet port 124, a pendent portion 160 is formed (see FIGS. 6 and 7). The pendent portion 160 has, on a front surface thereof, a positioning protrusion 161 in the shape of the letter E lying on its side. The end cap 122 also has a positioning protrusion 129 on a rear surface thereof (see FIG. 6). When the positioning protrusions 161 and 129 are engaged with each other, centerlines of the discharged gas cooling unit 3 and the cooker main body 2 superimpose on each other, and the discharged gas cooling unit 3 is inhibited from sliding in a right/left direction with respect to the cooker main body 2. That is, the positioning protrusions 129 and 161 serve as positioning means for positioning the cooker main body 2 and the discharged gas cooling unit 3.

When the discharged gas cooling unit 3 is placed on the cooker main body 2 such that the positioning protrusion 161 is engaged with the positioning protrusion 129, the inlet port 153 covers the outlet port 124; in this state, however, the inlet port 153 does not precisely fit the outlet port 124. That is, since the inlet port 153 is wider than the outlet port 124 in the front/rear direction, a rear part of the inlet port 153 lies off the outlet port 124, and thereby a gap 162 (see FIG. 9) is formed. The gap 162 serves as an ambient air inlet port. Incidentally, FIG. 9 shows that, in the outlet port 124 exist not only an air-flow guide plate extending in the right/left direction but also an air-flow guide plate extending in the front/rear direction. The air-flow guide plate extending in the front/rear direction includes a plurality of air-flow guide plates extending in the front/rear direction, which are arranged at predetermined intervals in the right/left direction.

The top surface portion of the casing 150 is composed of a detachable top lid. The top lid is divided into a front top lid 163 and a rear top lid 164 (see FIG. 8), both of which are snap-fittingly attached to the casing 150 by making use of elasticity of the synthetic resin. In FIG. 9, the dash-dot-dot line indicates a division line between the front and rear top lids 163 and 164. Needless to say, the front and rear top lids 163 and 164 form a top surface portion of the duct 152, and the interior of the main body of the duct 152 (part thereof except the top surface) appears when the front top lid 163 or the rear top lid 164 is detached.

Interior pressure of the duct 152 becomes positive downstream of the throat section 155. This tends to cause leakage of steam through a fitting portion between the top lids and the main body of the duct in the section from the throat portion 155 to the outlet ports 154. To prevent this, steam-leakage preventing means is provided in the fitting portion between the top lids and the main body of the duct in the section.

The steam-leakage preventing means is built as a complicatedly intricate rib structure. Specifically, upper ends of a side wall 152a of the main body of the duct and an outer side wall 150a of the casing 150 are linked with each other by a horizontal top wall 169. From a top surface of the top wall 169, two threads of ribs 169a and 169b protrude upward. The rib 169a extends parallel to the outer side wall 150a, and the rib 169b extends parallel to the side wall 152a. From the front top lid 163 side, a rib 163a extends downward from an outer edge of the front top lid 163, and from a position inward from the outer edge of the front top lid 163, a rib 163b extends downward. The rib 163a, together with the outer side wall 150a, forms the outer side wall of the casing 150; the rib 163b, together with the side wall 152a, forms an inner side wall of the duct 152. The ribs 169a and 169b are located between the ribs 163a and 163b.

Here, a lower end of the rib 163b and an upper end of the side wall 152a are firmly fitted to each other without a gap, or, if any, with an extremely narrow gap to prevent leakage of steam; an upper end of the rib 169a and a bottom surface of the front top lid 163 are firmly fitted to each other without a gap, or, if any, with an extremely narrow gap to prevent leakage of steam; an upper end of the rib 169b and the bottom surface of the front top lid 163 are firmly fitted to each other without a gap, or, if any, with an extremely narrow gap to prevent leakage of steam; and a lower end of the rib 163a and an upper end of the outer side wall 150a are firmly fitted to each other without a gap, or, if any, with an extremely narrow gap to prevent leakage of steam. In this way, leakage of steam is prevented at four positions, and this makes it possible to effectively prevent leakage of steam from the duct 152.

To prevent leakage of steam even more securely, a gasket may be laid between the lower end of the rib 163b and the upper end of the side wall 152a, between the upper end of the rib 169a and the bottom surface of the front top lid 163, between the upper end of the rib 169a and the bottom surface of the front top lid 163, or between the lower end of the rib 163a and the upper end of the outer side wall 150a.

Steam leakage preventing means as described above is also provided at the right side edge of the front top lid 163. Furthermore, in the rear top lid 164, steam leakage preventing means as described above is provided at a position in a section corresponding to “the section from the throat portion 155 and the outlet ports 154”.

To the front top lid 163 is attached a wind deflector 165 for deflecting wind blowing out from the outlet ports 154. The wind deflector 165 is of a type typically used at outlet ports of air conditioners, and built as a combination of a wind deflection plate for changing the up/down wind direction and a wind deflection plate for changing the right/left wind direction. The wind deflection plates are formed to be variable in angle, and thereby the wind direction can be freely adjusted in up/down and right/left directions. When the front top lid 163 is detached, the wind deflector 165 is taken out together.

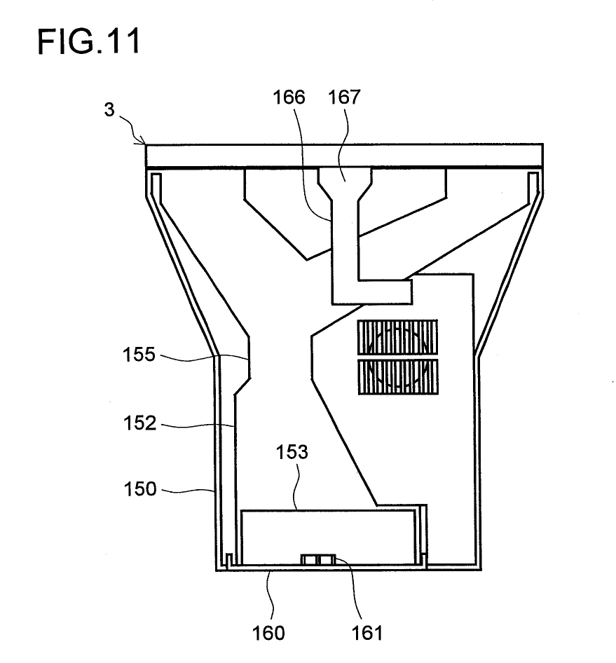

An isolation chamber 166 for electric/electronic components is defined on a bottom surface of the casing 150 (see FIG. 11). Accommodated in the isolation chamber 166 are electric/electronic components of the discharged gas cooling unit 3 such as a control board of the blower 157. A lid 167 of the isolation chamber 166 is, like the top lid, snap-fittingly attached to the casing 150 by making use of the elasticity of the synthetic resin.

In the section from the inlet port 153 to the throat portion 155 of the duct 152, the bottom surface of the duct 152 is lowered toward the inlet port 153, forming a water drain passage leading to the outlet port 124. In the section from the throat portion 155 to the outlet ports 154, the bottom surface of the duct 152 is lowered toward the outlet ports 154. Reservoir recesses 168 (see FIG. 5) are formed at the lowermost positions.

Next, a description will be given of the operation of the discharged gas cooling unit 3. The fan motor 158 starts to be driven at the same time that cooking is started in the cooker main body 2. Consequently, wind is blown out from the nozzle 156, and air is sucked in through the inlet port 153 due to the ejector effect created at the throat portion 155. The thus sucked-in air flows to the branch ducts 152L and 152R to be blown out from the outlet ports 154 formed at the ends of the branch ducts 152L and 152R. Incidentally, since hot gas is not discharged from the outlet port 124 immediately after the start of cooking, there may be a time lag before the blower 157 starts to be driven after the start of cooking.

Hot gas discharged from the outlet port 124 during cooking, that is, hot heat medium leaking out through the leak passage 77 and hot heat medium flowing out from the gas discharge passage 78 when the damper 79 is opened in the hot air cooking mode and in the steam cooking mode, or steam coming out from food when cooking is finished, is sucked from the inlet port 153 into the duct 152. The inlet port 153 is also sucking in ambient air through the gap 162, and the gas from the outlet port 124 is mixed with the ambient air and its temperature is lowered. At the same time, discharged steam contained in the gas is diluted so that it hardly causes a wall to become wet.

The thus diluted gas is discharged from the outlet ports 154 in the frontward direction (or in a diagonally frontward direction depending on adjustment by the wind deflector 165) of the cooker 1. Thus, even if the cooker 1 is placed in a narrow space in a kitchen such as a space under a shelf cupboard or between a wall and a refrigerator, steam does not stay in the narrow space. This helps prevent wall surface in the narrow space from becoming hot, or prevent condensation from forming on the surface of the wall.

It is the gap 162 formed between the inlet port 153 and the outlet port 124 that serves as the ambient air inlet port. This eliminates the need of separately preparing an ambient air inlet port, and thus a simple structure can be achieved. Furthermore, even if the outlet port 124 is located near the wall surface, ambient air flows along the wall surface when it is sucked in, and this helps prevent condensation from forming due to the discharged gas.

It is an ejector structure formed of the throat portion 155 and the nozzle 156 that generates a suction force at the inlet port 153. Since sucked-in gas does not flow through the blower 157, the blower 157 is prevented from being exposed to hot humid gas to be damaged.

The duct 152 is branched into branch ducts 152L and 152R on the downstream side of the throat portion 155. The branch ducts 152L and 152R extend to be increasingly away from each other, and have the outlet ports 154 formed at the ends of them. Thus, the outlet ports 154 are provided at two, right and left positions, avoiding the middle part of the cooker main body 2. Thus, even when the user stands in front of the cooker 1 to look into the 20 through the see-through part of the door 11 to check the cooking status, discharged gas flows away from the user. Thus, the user is free from the discomfort that would result from the discharged gas blowing directly to him/her. In addition, since discharged gas does not reach the handle 12, the surface of the handle 12 is prevented from becoming wet with water resulting from condensation, or becoming dirty with greasy fumes, the user is free from the discomfort that would result from his/her touching a wet or greasy handle.

Since the wind deflector 165 is provided at each of the outlet ports 154, the direction of discharged gas may be changed according to where the cooker 1 is placed so as to make discharged gas flow away from a position that should not be exposed to it.

When gas containing a large amount of steam passes through the duct 152, the steam condenses on the inner surface of the duct 152. The condensation flows down to the bottom surface of the duct 152, and since the bottom surface of the duct 152 is tilted except the throat portion 155, the condensation flows either in the front or rear direction. The part of the condensation that has flown toward the inlet port 153 flows into the outlet port 124 to be drained through the water drain port 126. This saves the user time and trouble of dealing with the condensation.

The part of the condensation that has flown toward the outlet ports 154 is collected in the reservoir recesses 168, and this prevents water from dripping down from the outlet ports 154.

After long-term use of the discharged gas cooling unit 3, the interior of the duct 152 becomes dirty with greasy fumes and the like. Then, the front and rear top lids 163 and 164 are detached to disclose the interior of the duct 152 to be cleaned. When the front top lid 163 is detached, the wind deflector 165 also appears, and it also can be cleaned.

The control board of the blower 157 is isolated and accommodated in the isolation chamber 166. In this way, the control board can be protected from the heat medium, steam, and greasy fumes.

The isolation chamber 166 may communicate with the inlet portion of the blower 157, and part of the lid 167 may be formed as an air inlet portion. With this structure, the control board can be air-cooled. Here, partitions or the like should be properly provided to prevent heat medium or steam from intruding through the air inlet portion.

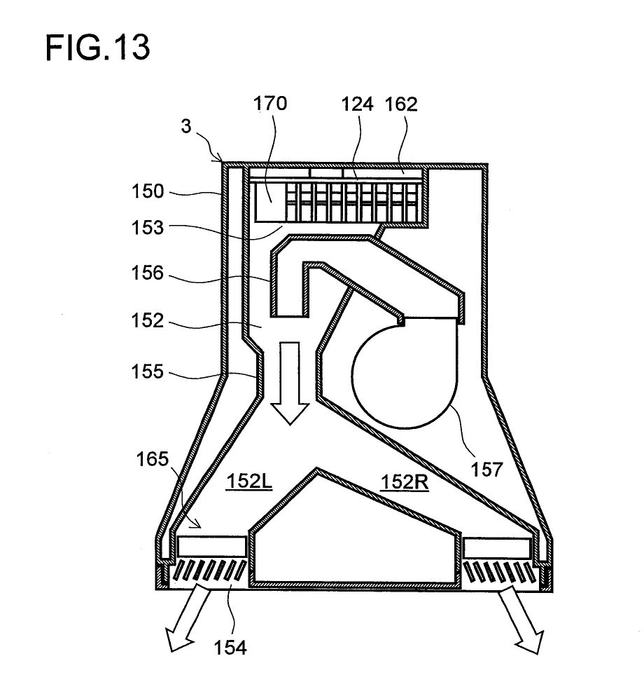

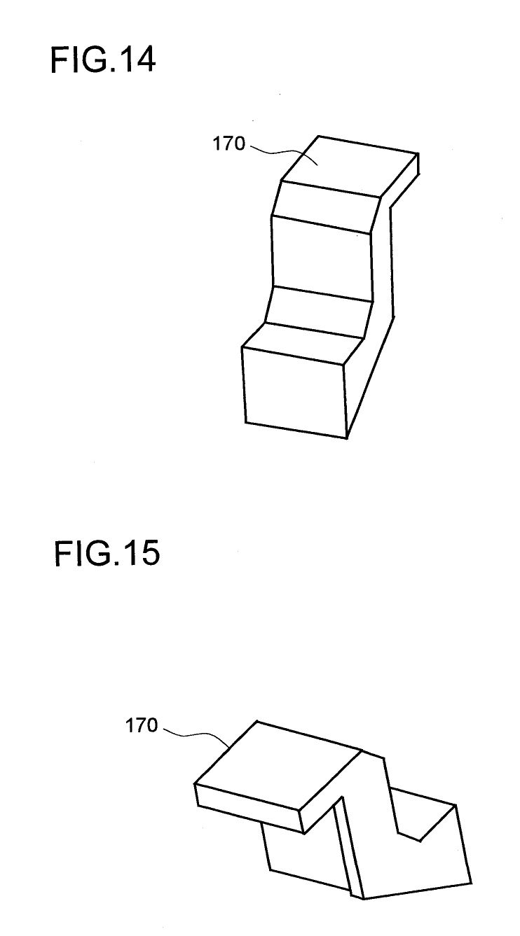

The discharged gas cooling unit 3 is intended to be used with different types of cooker main bodies 2. Outlet ports 124 of different types of cooker main bodies 2 have different shapes, to which the discharged gas cooling unit 3 needs to be fitted. The mechanism will be described with reference to FIGS. 13 to 15. FIG. 13 is a horizontal sectional view of the discharged gas cooling unit shown in FIG. 9, and FIGS. 14 and 15 are perspective views showing an adapter as seen from different angles.

In FIG. 13, the discharged gas cooling unit 3 is combined with the cooker main body 2 whose outlet port 124 has a narrow width in the right/left direction. With this structure, if no measure is taken, a large gap is formed between the left edge of the outlet port 124 and the left edge of the inlet port 153, and, although a large amount of ambient air can be taken in through the large gap, only a small suction force is applied to the outlet port 124. To deal with this, an adapter 170 shaped as shown in FIGS. 14 and 15 is fitted into the gap between the left edge of the outlet port 124 and the left edge of the inlet port 153 to plug the gap. This prevents excessive suction of ambient air, and a predetermined suction force can be applied to the outlet port 124. Preparation of several types of adapters 170 allows the discharged gas cooling unit 3 of a single type to be compatible with many types of cooker main bodies 2.

Descriptions have been given of the embodiments of the present invention, and it should be understood that, in the embodiments described above, many other modifications and variations are possible within the scope of the present invention.

### INDUSTRIAL APPLICABILITY

The present invention finds wide application in cookers that discharge steam.

1. A discharged steam diluting device diluting steam discharged from a cooker through a gas discharge passage, the discharged steam diluting device comprising:
a duct simultaneously sucking in and mixing steam discharged from the cooker with ambient air,
wherein
an outlet port of the duct is open in a predetermined direction.

2. The discharged steam diluting device of claim 1, wherein the predetermined direction in which the outlet port of the duct is open is a frontward direction or a diagonally frontward direction of the cooker.

3. The discharged steam diluting device of claim 1,
wherein the duct has an inlet port at one end thereof and the outlet port at an other end thereof,
wherein the inlet port is located so as to cover an outlet port of the gas discharge passage, and port.
wherein a gap between the inlet port and the outlet port functions as an ambient air inlet port.

4. The discharged steam diluting device of claim 1, wherein a wind deflector is provided in the outlet port.

5. The discharged steam diluting device of claim 1,
wherein a throat portion having a reduced flow passage area is formed in the duct, and
wherein wind from a blower is blown into the throat portion through a nozzle disposed coaxially with the throat portion to generate a suction force in the inlet port.

6. The discharged steam diluting device of claim 5,
wherein the duct is branched into two branch ducts on a downstream side of the throat portion, the two branch ducts each extending in diagonal directions to be increasingly away from each other, and
wherein the outlet port is formed one at an end of each of the branch ducts.

7. The discharged steam diluting device of claim 5, wherein a bottom surface of the duct is lowered toward the inlet port in a section from the inlet port to the throat portion to form a water drain passage for draining water to the outlet port.

8. The discharged steam diluting device of claim 5, wherein a bottom surface of the duct is lowered toward the outlet port in a section from the throat portion to the outlet portion, and a reservoir recess is formed at a lowermost position.

9. The discharged steam diluting device of claim 1, wherein at least part of a top surface portion of the duct is formed detachable.

10. The discharged steam diluting device of claim 5,
wherein at least part of a top surface portion of the duct is formed detachable, and
wherein steam-leakage preventing means is provided at a fitting portion between the at least part of the top surface portion of the duct that is formed detachable and a main body of the duct at least in a section from the throat portion to the outlet port.

11. The discharged steam diluting device of claim 5, wherein the duct and the blower form a detachable discharged gas cooling unit that is separate from the cooker main body.

12. The discharged steam diluting device of claim 11,
wherein, in the discharged gas cooling unit and in the cooker main body, positioning means is provided for determining relative positions of the discharged gas cooling unit and the cooker main body with respect to each other, and
wherein an adapter is prepared for adapting the inlet port to the gas discharge passage.

13. The discharged steam diluting device of claim 11,
wherein the discharged gas cooling unit and the cooker main body are connected to each other with a connector such that the discharged gas cooling unit is supplied with power and controlled from the cooker main body.

14. The discharged steam diluting device of claim 11, wherein an electrical/electronic component isolation chamber is formed under a bottom surface of the discharged gas cooling unit.

15. The discharged steam diluting device of claim 11, wherein part of a top surface portion of the discharged gas cooling unit is formed as a detachable top lid that can be detached to disclose an interior of the duct.

16. The discharged steam diluting device of claim 15,
wherein the top lid is divided into front and rear top lids, and
wherein a wind deflector is provided in the front top lid for deflecting wind blowing out from the outlet port.

17. A cooker combined with the discharged steam diluting device of claim 1.

18. A cooker combined with the discharged steam diluting device of claim 2.

19. A cooker combined with the discharged steam diluting device of claim 3.

20. A cooker combined with the discharged steam diluting device of claim 4.

21. A cooker combined with the discharged steam diluting device of claim 5.

22. A cooker combined with the discharged steam diluting device of claim 6.

23. A cooker combined with the discharged steam diluting device of claim 7.

24. A cooker combined with the discharged steam diluting device of claim 8.

25. A cooker combined with the discharged steam diluting device of claim 9.

26. A cooker combined with the discharged steam diluting device of claim 10.

27. A cooker combined with the discharged steam diluting device of claim 11.

28. A cooker combined with the discharged steam diluting device of claim 12.

29. A cooker combined with the discharged steam diluting device of claim 13.

30. A cooker combined with the discharged steam diluting device of claim 14.

31. A cooker combined with the discharged steam diluting device of claim 15.

32. A cooker combined with the discharged steam diluting device of claim 16.
